(19) United States
(12) Patent Application Publication
(10) Pub. No.: US 2013/0215499 A1
(43) Pub. Date: Aug. 22, 2013

(54) NOTCH FILTER SYSTEM USING SPECTRAL INVERSION

(71) Applicants: Ligang Wang, Penfield, NY (US); Turan Erdogan, Spencerport, NY (US)

(72) Inventors: Ligang Wang, Penfield, NY (US); Turan Erdogan, Spencerport, NY (US)

(73) Assignee: SEMROCK, INC., Rochester, NY (US)

(21) Appl. No.: 13/400,736

(22) Filed: Feb. 21, 2012

(51) Int. Cl. G02B 5/28

(52) U.S. Cl. 359/359

(57) ABSTRACT

An optical filter apparatus transmits less than 5% of light within a notch spectral range about a central line wavelength with a notch bandwidth, and transmits more than 90% of light within a transmission spectral range that extends over an adjacent pass band of longer and shorter wavelengths and excludes the notch. The apparatus has a first thin film interference filter and a second thin film interference filter in the path of incident light reflected from the first filter. The first and second thin film interference filters are each treated to transmit light of the notch spectral range and reflect light of the transmission spectral range and each have thin film layers formed on a substrate, including first layers having a first refractive index, and second layers having a higher second refractive index. The notch bandwidth at full width half transmission is less than 5% of the central line wavelength.

### CROSS-REFERENCE TO RELATED APPLICATIONS

Reference is made to commonly assigned U.S. patent application Ser. No. 12/238,228 entitled “Optical Thin-film Notch Filter with Very Wide Pass Band Regions” by Turan Erdogan and Ligang Wang, incorporated herein by reference; and to commonly assigned U.S. patent application Ser. No. 12/129,534 entitled “Interference Filter for Non-zero Angle of Incidence Spectroscopy” by Turan Erdogan and Ligang Wang, incorporated herein by reference.

### FIELD OF THE INVENTION

This invention generally relates to thin film optical filters and more particularly to an arrangement of thin film optical filters that provide a narrow band notch filter.

### BACKGROUND OF THE INVENTION

Thin film interference filters are widely used in systems for optical measurement and analysis, such as Raman spectroscopy and fluorescence imaging, for example. Thin film interference filters, including optical edge filters, notch filters, and laser line filters (LLFs) are advantageously used in such systems to block unwanted light that could otherwise constitute or generate spurious optical signals and swamp the signals to be detected and analyzed. Failure or poor performance of such filters compromises the performance of systems in which they are used.

In general, thin-film interference filters are treated or formed to be wavelength-selective as a result of the interference effects that take place between incident and reflected waves at boundaries between interleaved layers of materials having different refractive indices. Interference filters conventionally include a dielectric stack composed of multiple alternating layers of two or more dielectric materials having different refractive indices. Moreover, in a conventional thin-film interference filter, each of the respective interleaved layers of the filter stack is very thin, e.g., having an optical thickness (physical thickness times the refractive index of the layer) on the order of a quarter wavelength of light. These layers may be deposited on one or more substrates (e.g., a glass substrate) and may be interleaved in various configurations to provide one or more band-pass, or band-rejection filter characteristics. A filter that substantially reflects at least one band of wavelengths and substantially transmits at least a second band of wavelengths immediately adjacent to the first band, such that the filter enables separation of the two bands of wavelengths by redirecting the reflected band, is conventionally called a “dichroic beamsplitter,” or simply a “dichroic” filter.

As used herein, the “blocking” of a filter at a wavelength, or over a range of wavelengths, is typically measured in optical density (“OD” where OD=−log₁₀(T), T being transmission of the filter at a particular wavelength, with a value between 0 and 1). Conventional filters that achieve high OD values at certain wavelengths or over a range of wavelengths may not necessarily also achieve high transmission (in excess of 50%, for example) at any other wavelengths, or over other ranges of wavelengths. For the common layer structure that contains a stack of quarter-wave-thick layers, high OD is exhibited in a fundamental “stopband” wavelength region. Associated with these stopbands are also higher-order harmonic stopband regions that occur at other wavelength regions. An OD value can be expressed as “OD 6” or alternately “6 OD”.

Edge filters, as used herein, are treated or configured to exhibit a transmitted spectrum having a defined edge, where unwanted light having wavelengths above or, alternatively, below a chosen “transition” wavelength λ_{T} is blocked, and where desired light is transmitted on the opposite side of λ_{T}. Edge filters formed to transmit optical wavelengths longer than λ_{T} are called long-wave-pass (LWP) filters, and those that are formed to transmit wavelengths shorter than λ_{T} are short-wave-pass (SWP) filters. In addition, as used herein, edge filters are configured such that the wavelength range over which the transmission characteristics transition from “blocking” to “transmitting” or vice versa is substantially smaller (i.e., at least one order of magnitude smaller, and usually two orders of magnitude smaller or more) than the wavelength ranges over which the “blocking” and “transmitting” characteristics are exhibited.

Edge steepness and the relative amount of transmitted light can be important parameters in many filter applications. As discussed above, an idealized edge filter may be considered to have a precise wavelength edge that is represented by a vertical line at wavelength λ_{T} in a plot of transmission versus wavelength. As such, an idealized filter has an “edge steepness” (expressed in terms of the change in wavelength nm over which the transmission characteristics transition from a “blocking” to “transmitting” or vice versa) of 0 nm at λ_{T}. However, real edge filters change from blocking to transmitting over a small but non-zero range of wavelengths, with increasing values of edge steepness reflecting an edge that has increasingly less slope. The transition of a real edge filter is therefore more accurately represented by a non-vertical but highly sloped line at or near λ_{T}. Similarly, while an ideal edge filter may be considered to transmit all of the incident light in the transmission region (transmission T=1), real edge filters have some amount of transmission loss, invariably blocking a small portion of the light in the intended transmission region (T<1). As a result, the edge steepness of a real edge filter can be considered to be dependent upon the transmission range over which it is defined.

Systems that benefit from wavelength selection through optical filtering can be expected to benefit from an optical filter that exhibits high transmission in the filter passband regions, highly sloped spectral edges, and high out-of-band blocking of undesired wavelengths. Consequently, thin-film optical filters that are capable of providing close to 100% transmission, that exhibit highly sloped spectral edges (transitioning from high transmission to blocking of optical density 6 or higher in less than 1% of the edge wavelength), and that exhibit blocking of optical density OD 6 or higher over well-defined spectral regions, can be considered beneficial to such systems.

Notch filters are one type of filter used in optical measurement systems. The notch filter has a spectral characteristic that includes high transmission over a range of wavelengths, with at least one “notch” that includes a specific wavelength or narrow band of wavelengths that are substantially blocked, or not transmitted by the filter. An idealized notch filter has the spectral characteristic shown in the graph of transmission of FIG. 1A. On each side of a narrow notch region N1, centered at a notch wavelength λN are pass bands PB1 and PB2 of high transmission. In the context of the present disclosure, a transmission region TR is defined to encompass the pass bands on each side of the notch, PB1 and PB2, and to exclude only the notch region N1. The idealized filter characteristic of FIG. 1A is well suited to optical systems such as fluorescence, Raman, or other systems that direct narrow-band excitation light of wavelength λN toward a sample and measure or view the optical response of the sample at other wavelengths.

The performance of a notch filter is generally based on how well it blocks the needed notch wavelength λN and wavelength band N1, on how well it transmits the adjacent pass band wavelengths PB1 and PB2, and on the relative steepness of the edges E1 and E2 that define the transition between the notch and the surrounding pass bands. Specific parameters that are used to describe notch filter quality and performance include the following:
(i) Notch band width NBW. Because of the typical applications in which it is used, it is generally desirable for the notch filter to completely block only a small range of wavelengths, such as wavelengths within the laser line width λN range, also termed the notch spectral range. Thus, narrower band widths with steep transition edges are generally desirable for this purpose. Notch bandwidths are typically specified as a percentage of the central notch wavelength, typically laser line λN, and are generally no narrower than about a few % of λN at FWHT (Full Width at Half Transmission, a metric described in more detail subsequently). At this scale, typical notch filter band widths for conventional thin film designs often well exceed the laser line width of the light to be blocked.
(ii) Blocking. High attenuation is needed, with blocking as high as OD 4, 6 or even higher for the notch wavelengths within the notch spectral range about λN. Thin film designs are capable of sufficiently high blocking levels in this range; however, blocking (ii) and band width (i) are not independent of each other with conventional thin film design approaches so that, for example, deeper blocking generally means a larger notch band width.
(iii) Extent of the transmission spectral range TR outside of the notch region. As the idealized spectral characteristic of FIG. 1A shows, transmission spectral range TR encompasses the pass bands PB1 and PB2 that are immediately adjacent to the notch, shown as N1. In a sensing application, for example, it is advantageous to have transmission spectral range TR as large as possible, so that TR extends over any wavelengths that might be generated from a sample that has been excited by light of laser line wavelength λN. Conventional thin film designs can perform satisfactorily in providing a sufficiently broad transmission spectral range TR outside of the notch region for most applications. However, there is room for improvement and an expanded transmission range.
(iv) High transmission over the transmission spectral range TR outside of the notch region. Related to the extent of TR in (iii) above, uniformly high transmission over pass bands PB1 and PB2 is desirable. For example, attenuation over spectral range TR would negatively impact sensitivity to light that has been excited from a sample.
(v) Low ripple over the transmission spectral range TR outside of the notch region. Ripple over transmission spectral range TR is undesirable and adversely affects the sensitivity and performance of a sensing system using the notch filter. With conventional thin film notch filter designs, various resonant conditions in the filter design itself may cause the pass bands to have some amount of ripple, potentially blocking some of the desired light. Ripple can be particularly troublesome in spectroscopy applications, where the relative levels of light signals at different wavelengths in the pass bands must be accurately measured.

In addition to these performance parameters, other considerations for notch filter design include practical concerns of size, cost, flexibility, and ability for tuning to adjust the notch center wavelength (wavelength λN) over a range of values.

In practice, conventional notch filter designs fall short of ideal characteristics for performance and practicality and may not meet all of the requirements listed above in (i)-(v) in a satisfactory manner. The shape of the spectral characteristic graph for a more realistic notch filter, for comparison against the idealized view of FIG. 1A, is shown in FIG. 1B. The real-world notch filter of FIG. 1B has transmission less than 100%, edges E1 and E2 of less than ideal steepness, and a bandwidth NBW extending from (λN−NBW/2) to (λN+NBW/2) that often well exceeds the bandwidth of the laser line or other signal to be blocked. In addition, in conventional thin film notch filters, fundamental and higher-harmonic spectral stop bands often constrain pass band width. Ripple R is difficult to eliminate and degrades filter performance in signal measurement applications. Cascading of conventional thin film notch filters to improve performance is generally not worthwhile, since this tends to accentuate the effects of ripple, tends to degrade transmission outside of the notch region, and requires deliberate separation and misalignment of the cascaded filters in order to yield appreciable gains in blocking.

Technologies other than thin-film approaches have been used for notch filter and adjustable notch filter design capabilities, but have notable limitations.

Holographic notch filters, for example, provide a narrow notch with relatively steep edges; however, higher levels of optical noise often result both from limited blocking and increased scattered light, which can require additional expense for correction in the optical system. Moreover, these filters are complex in structure, difficult to mass-produce, less reliable (due to the use of dichromated gelatin), and higher in cost than other notch filter solutions. Rugate notch filters have also been used for optical notch filters, but do not readily provide sufficient attenuation of the notch wavelength. Transmission for pass band light can also be disappointing. Rugate filters can be costly to produce since most thin-film deposition systems are based on the principle of depositing a single material at a time, whereas Rugate notch filters require sensitive, continuous adjustment of the relative rates of simultaneous deposition of two or more materials. Liquid-crystal tunable filters (LCTF) can also be designed to exhibit variable spectral functions including notch filtering, but are subject to problems such as poor transmission, poor edge steepness, fixed bandwidth, low laser damage threshold (LDT), and high polarization dependency. Acousto-optic tunable filters (AOTF) are widely tunable and capable of high tuning speeds, but are disadvantaged for notch filter design due to poor transmission and edge steepness, lack of adjustable bandwidth, very small apertures, and high polarization dependency.

Thin film notch filters have been designed with some success, but challenges remain. It proves difficult to provide narrow notch bandwidths with steep transition edges with thin film notch filter designs, particularly while attempting to maintain high, ripple-free transmission over the pass bands PB1 and PB2. For example, commonly assigned co-pending patent application (Ser. No. 12/238,228) describes improved thin film designs for narrow-band notch filters formed or treated to have steep transition edges, with wider uninterrupted pass bands than achievable with conventional designs. However, even though such advanced designs offer improved blocking and other spectral characteristics, there are trade-offs between bandwidth and blocking, edge steepness, and ripple; additionally, there are practical limits on film thickness, and therefore the notch bandwidth, and other characteristics that strongly suggest that there are limits to how well a thin film notch filter design can satisfy all of the ideal requirements for characteristics (i)-(v) listed previously.

As just one example, there appear to be practical limits on film thickness, making it difficult to design a notch filter having a notch bandwidth NBW that is less than about 20 nm for visible wavelengths. In particular, it has been found that the bandwidth of a thin-film notch filter is inversely proportional to the number of layers used and, thus, the thickness of the filter. A narrower notch requires a thicker filter and, therefore, more thin-film layers at a higher cost. Given that the maximum thickness of a thin-film filter can be limited by numerous practical considerations, typically thin-film notch filter bandwidths are limited to several % of the notch wavelength, wider than would be ideal.

Thus, it can be seen that there is a need for a notch filter design that takes advantage of the benefits of multilayer thin-film composition and provides improved performance over conventional notch filter devices.

### SUMMARY OF THE INVENTION

It is an object of the present invention to advance the art of optical filtering. With this object in mind, the present invention provides apparatus and methods for providing a thin film optical notch filter formed from two or more reflective filter components arranged in cascade to provide improved performance.

Embodiments of the present invention provide an optical notch filter with the advantages of thin film optical design. Notch filters formed using methods of the present invention can provide high levels of light blocking, high edge steepness with little or no perceptible polarization splitting, narrow notch bandwidths, and high transmission with very low ripple over sizable pass bands above and below the notch band wavelength.

According to an embodiment of the present invention, there is provided an optical filter apparatus that transmits less than 5% of incident light that lies within a notch spectral range about a central line wavelength λN and having a notch bandwidth NBW, and that transmits more than 90% of the light within a transmission spectral range TR that extends over an adjacent pass band of longer wavelengths than the notch spectral range and an adjacent pass band of shorter wavelengths than the notch spectral range and excludes the notch spectral range, the optical filter apparatus comprising:
a first thin film interference filter; and
at least a second thin film interference filter in the path of the incident light reflected from the first thin film interference filter;
wherein the first and at least the second thin film interference filters are each formed to transmit light of the notch spectral range and to reflect light of the transmission spectral range TR, and
wherein the first and second thin film interference filters each comprise a corresponding substrate with a plurality of thin film layers formed on the substrate, the plurality of layers including at least a plurality of first layers having a first refractive index, n_{L} and a plurality of second layers having a second refractive index, n_{H}, greater than the first refractive index;
   wherein the notch bandwidth NBW at full width half transmission is less than 5% of the central line wavelength λN.

Additional features and advantages will be set forth in part in the description which follows, being apparent from the description or learned by practice of the disclosed embodiments. The features and advantages will be realized and attained by means of the elements and combinations particularly pointed out in the appended claims.

It is to be understood that both the foregoing general description and the following detailed description are exemplary and explanatory only, and are not restrictive of the scope of the embodiments as claimed.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings.

FIG. 1A is a graph which shows spectral characteristics of an idealized notch filter.

FIG. 1B is a graph which shows, by way of example, the spectral characteristic that more closely represents the spectral response of an actual notch filter design.

FIG. 2A is a schematic block diagram which shows components of an optical notch filter apparatus using spectral inversion according to an embodiment of the present invention.

FIG. 2B provides graphs showing idealized spectral characteristics of filters and the resultant effect on incident light at different points in the apparatus of the embodiment of FIG. 2A.

FIG. 2C is a graph showing a transmission spectral characteristic for band pass filters used in an embodiment of FIG. 2A.

FIG. 2D is a graph which shows the spectral characteristic of FIG. 2C with the wavelength on an enlarged scale.

FIG. 2E is a graph which shows the spectral characteristics formed using the arrangement of filters in FIG. 2A, with the light level after each stage of the arrangement measured on a linear scale.

FIG. 2F is a graph which shows the spectral characteristic of FIG. 2E with the wavelength on an enlarged scale.

FIG. 2G is a graph which shows the spectral characteristics formed using the arrangement of filters in FIG. 2A, with optical density on a log scale.

FIG. 2H is a graph of the spectral characteristic of FIG. 2G with the wavelength on an enlarged scale.

FIG. 3 is a schematic block diagram which shows components of an optical notch filter apparatus according to an alternate embodiment of the present invention which uses only two filter surfaces, and with the output light emerging parallel to the input light.

FIG. 4 is a schematic block diagram which shows components of an optical notch filter apparatus according to an alternate embodiment of the present invention which uses only two filter surfaces, and with the output light emerging non-parallel to the input light.

FIG. 5 is a schematic block diagram which shows components of an optical notch filter apparatus according to an alternate embodiment of the present invention which uses only two filter surfaces and directs output light orthogonal relative to the input light.

FIG. 6A is a schematic block diagram which shows an optical notch filter apparatus using three filters, one used in transmission and two used in reflection.

FIG. 6B is a schematic block diagram which shows the filter arrangement of FIG. 6A, but not formed on prism surfaces.

FIG. 6C is a schematic block diagram which shows an embodiment of a notch filter apparatus using only the reflective filters of the FIG. 6B embodiment.

FIG. 7 is a schematic block diagram which shows an arrangement of transmissive and reflective filters for providing a notch filter apparatus with output light directed 180 degrees from the input light.

FIG. 8 is a schematic block diagram which shows an alternate embodiment of the present invention with an optical notch filter apparatus having four filters, each used in reflection.

FIG. 9 is a schematic block diagram which shows an alternate embodiment of the present invention formed on a composite prism.

FIG. 10A is a schematic block diagram which shows an alternate embodiment of the present invention using four interference filters.

FIG. 10B is a schematic block diagram which shows an alternate embodiment of the present invention using four interference filters with a smaller incident angle than shown in FIG. 10A.

FIG. 10C is a schematic block diagram which shows an alternate embodiment of the present invention using four interference filters with a smaller incident angle than shown in FIG. 10B.

FIG. 10D is a schematic block diagram which shows an alternate embodiment of the present invention using four interference filters with a smaller incident angle than shown in FIG. 10A.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

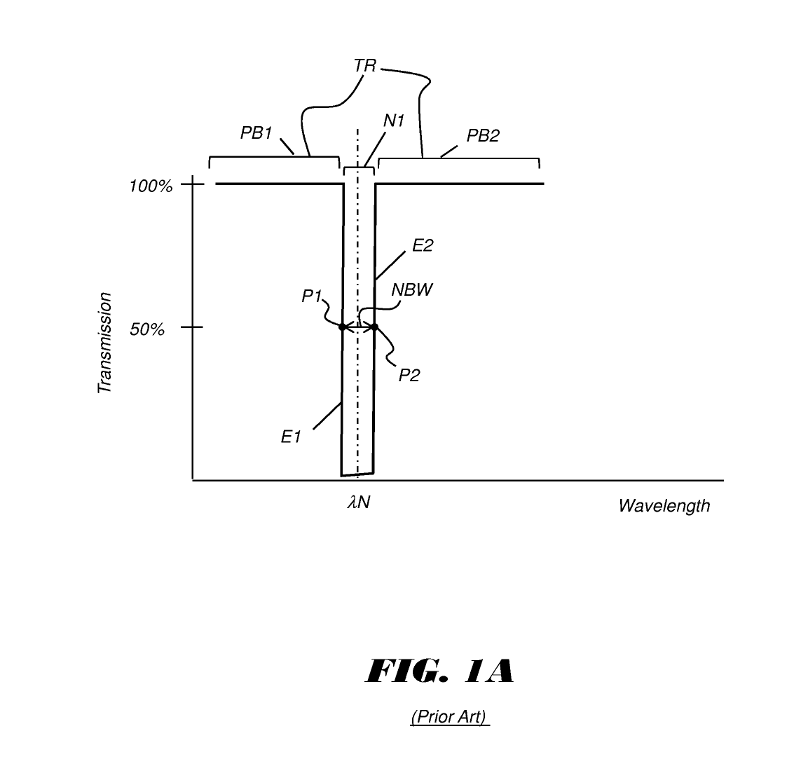

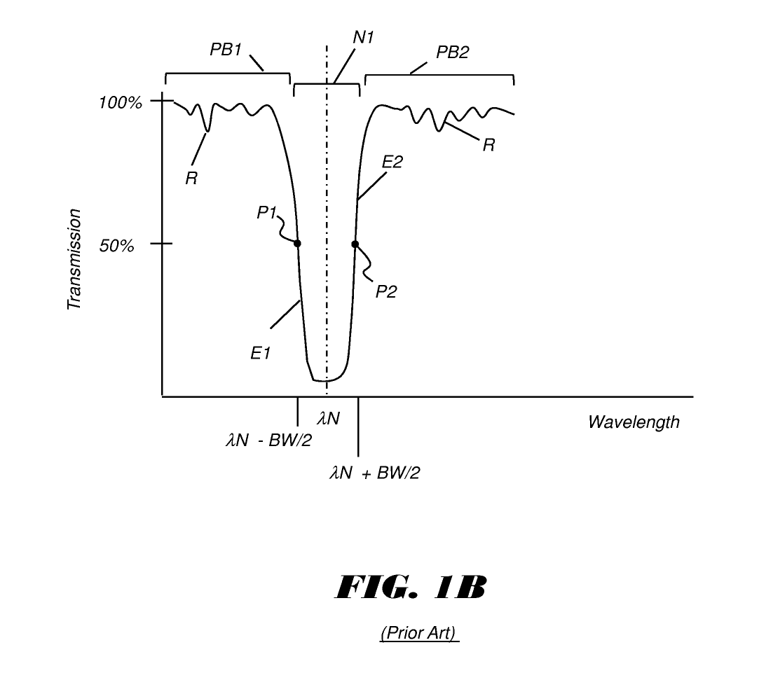

Figures shown and described herein are provided in order to illustrate key principles of operation and component relationships along their respective optical paths according to the present invention and are not drawn with intent to show actual size or scale. Some exaggeration may be necessary in order to more clearly emphasize basic structural relationships or principles of operation. Where they are used, the terms “first”, “second”, “third”, and so on, do not necessarily denote any ordinal or priority relation, but are simply used to more clearly distinguish one element from another. The term “adjacent” applied to pass bands refers to continuous pass bands PB1 and PB2 that are immediately adjacent to, that is abut, the notch N1 as shown in FIG. 1A. The term “oblique” is used herein to refer to an angular relationship that is other than substantially orthogonal or parallel, that is, at least about 5 degrees from any integer multiple of 90 degrees.

The term “prism” or “prism element” is used herein as it is understood in optics, to refer to a transparent optical element that is generally in the form of an n-sided polyhedron with flat surfaces upon which light can be incident and that is formed from a transparent, solid material that refracts light which enters and exits the element. It is understood that, in terms of shape and surface outline, the optical understanding of what constitutes a prism is less restrictive than the formal geometric definition of a prism and encompasses that more formal definition. In optics, for example, the term “prism” is also used in reference to a composite element, formed from two or more component prism elements that are glued or otherwise coupled together, including composite elements that are mechanically coupled but have a thin gap at the interface between them filled with air or epoxy, for example.

In the context of the present disclosure, the terms “central line wavelength” and “central notch wavelength” are considered equivalent and are denoted λN. The terms “configured”, “treated”, or “formed” are used equivalently with respect to the fabrication of thin film filters designed to provide a particular spectral characteristic.

The background section described some of the difficulties encountered in achieving good performance with conventional thin film notch filter designs. Embodiments of the present invention take an alternate approach to notch filter design and use a plurality of two or more thin film interference filter surfaces in an arrangement that provides a notch filter using spectral inversion. The term “spectral inversion” as used here describes an apparatus which provides high throughput of light at a first set of wavelengths and high attenuation at a second set of wavelengths using individual interference filter components within the apparatus which are configured or formed to provide high reflection at the first set of wavelengths and high transmission at the second set of wavelengths. In other words, the spectrum of light that emerges from the apparatus is an inverted version of the spectrum of light transmitted through the individual components in the apparatus. Specifically, unlike conventional methods for notch filter design using thin film layers, embodiments of the present invention employ the path of reflected light that is cascaded from one component filter to the next, rather than using the path of transmitted light that is normally used for notch filter design.

In the context of the present disclosure, it is useful to define a number of terms related to interference filter design as these terms are used by those skilled in the design of thin film optical surfaces. In the idealized notch filter spectral characteristic of FIG. 1A, notch region N1 has a first short-wave-pass or cut-off edge E1 and a second long-wave-pass or cut-on edge E2. A notch band width NBW is measured between points P1 and P2 on respective edges E1 and E2 at a height determined by the FWHT (Full Width at Half Transmission). In the example of FIG. 1A, FWHT is measured between points P1 and P2, each at the 50% transmission level, that is, at OD 0.3. The “half transmission” in FWHT is referenced to ideal 100% transmission and thus is always 50%.

The terms “notch” and “notch band” refer to a continuous region of wavelengths over which an optical filter exhibits low transmission, below at least about 5%, or preferably below 1%, for a weakly attenuating notch filter, and below at least about 10⁻⁴ (OD 4), or preferably 10⁻⁶ (OD 6) or below for a highly attenuating notch filter. The notch bandwidth NBW can be less than 5% and preferably even less than 3% of the central line wavelength or central notch wavelength λN at FWHT (Full Width at Half Transmission) using embodiments of the present invention. Notch bandwidths of less than 1% of the central line wavelength λN at FWHT can even be achieved. The bandwidth NBW of a notch filter according to an embodiment of the present invention is significantly narrower than the bandwidth of a typical primary or fundamental stop band that is provided by a conventional quarter-wave stack that is the basic building block of most thin film filters.

Optical filters formed or configured according to embodiments of the present invention generally employ the basic structure of a thin film interference filter as described in the background section. In this basic structure, a plurality of discrete layers of material are deposited onto a surface of a substrate in some alternating or otherwise interleaved pattern as a filter stack, wherein the optical index between individual layers in the filter stack changes abruptly, rather than continuously or gradually. In conventional thin film designs, two discrete layers are alternated, formed with thicknesses very near the quarter-wavelength thickness of some fundamental wavelength. In embodiments of the present invention, the same basic pattern can be used, as well as the addition of a third or other additional materials in the thin film stack, as needed to fine-tune filter response.

A wide variety of materials may be used to form the plurality of discrete material layers in the filter stack. Among such materials, non-limiting mention is made of metals, metallic and non-metallic oxides, transparent polymeric materials, and so-called “soft” coatings, such as sodium aluminum fluoride (Na₃AlF₆) and zinc sulfide (ZnS). Further non-limiting mention is made of metallic oxides chosen from silicon dioxide (SiO₂), tantalum pentoxide (Ta₂O₅), niobium pentoxide (Nb₂O₅), hafnium dioxide (HfO₂), titanium dioxide (TiO₂), and aluminum pentoxide (Al₂O₅).

In some embodiments, the plurality of interleaved material layers may include at least two distinct materials. As a non-limiting example, the filters according to the present disclosure may include a plurality of distinct alternating Nb₂O₅ and SiO₂ layers which have indices of refraction of 2.3 and 1.5, respectively. Alternatively, the filters in accordance with the present disclosure may use an interleaved pattern with at least three distinct materials, such as distinct Nb₂O₅, SiO₂, and Ta₂O₅ layers, each layer having a characteristic index of refraction. Of course, more than three materials and other combinations of materials may also be used within the interleaved layer pattern.

Generally, the filters in accordance with the present disclosure can be manufactured using deposition methods and techniques that are known in the art. For example, these filters may be made with a computer controlled ion beam sputtering system, such as is described in commonly assigned U.S. Pat. No. 7,068,430, which is incorporated herein by reference. In general, such a system is capable of depositing a plurality of discrete alternating material layers, wherein the thickness of each layer may be precisely controlled.

Filter designs that specify the layer arrangement in accordance with the present disclosure may be produced by known thin-film filter design techniques. For example, these filter designs may be produced by optimizing the filter spectra and structure of an initial design, such as a traditional multicavity Fabry Perot narrow bandpass interference filter, against a target spectrum using known optical optimization routines. Non-limiting examples of such optimization routines include the variable-metric or simplex methods implemented in standard commercial thin-film design software packages, such as TFCalc by Software Spectra, Inc. of Portland, Oreg., and The Essential Macleod by Thin Film Center, Inc., of Tucson, Ariz. A detailed description of filter design techniques that can be used to produce filter designs according to the present disclosure may be found in U.S. Pat. No. 7,068,430, as noted previously, and in related work that describes associated algorithms adapted more particularly to narrow bandpass and notch filter designs, as described in commonly assigned U.S. Pat. Nos. 7,119,960 and 7,123,416, respectively, also incorporated herein by reference.

As used herein, the term, “pass band” refers to a continuous region of wavelengths over which a notch filter exhibits high transmission of light (for example, greater than or equal to 90%). Thus, the term, “pass band bandwidth,” refers to the continuous range of wavelengths extending from a long- or short-wave pass edge of a fundamental stop band or notch band of the filter, and over which the filter exhibits high transmission. Further, values associated with the term “pass band bandwidth” are generally reported herein without regard to the presence of a narrow notch band (or bands) that may interrupt the pass band, but are not the fundamental notch band of the filter. The term “pass band bandwidth” can also refer to the range of wavelengths within individual pass band regions located to the long and short wave side of a notch band (or bands).

As used herein, the term “configured,” means that at least one of the materials chosen to make up the basic structure, the individual layer thicknesses, and/or the overall geometry of the filter structure is chosen to obtain a filter that exhibits desired optical properties.

Conventionally, as noted in the background section, thin film interference filters that are configured as notch filters operate in transmission. In this mode, for incident light directed to the filter, light of the notch filter bandwidth is reflected from the filter, and therefore blocked from transmission through the filter. Light of the pass bands is transmitted through the filter.

The previous background section listed a number of desired characteristics by which notch filter performance can be assessed: (i) narrow notch band width NBW; (ii) deep blocking of at least 4 OD or better; (iii) broad transmission spectral range TR outside of the notch region; (iv) high transmission over the transmission spectral range TR outside of the notch region; and (v) low ripple. As noted earlier, transmissive thin film notch filter designs are unable to provide bandwidths of less than about 3% of the notch wavelength (or about 15 nm for visible wavelengths) and, when using conventional design practices, provide pass band transmission levels that are imperfect at best. Pass band ripple is another performance shortcoming that appears to be inherent to transmissive thin film notch filters. Approaches proposing the use of multiple transmissive thin film notch filters in series offer little appreciable improvement with respect to blocking (OD); using multiple cascaded notch filters is generally not a favorable approach due to undesirable reflection effects, added ripple, and reduced overall transmission of the desired light.

Embodiments of the present invention utilize an alternate approach to conventional transmission mode designs for thin film notch filters, forming a notch filter as a combination of cascaded thin film filters that operate in reflection. Using a combination of cascading and spectral inversion due to reflection, embodiments of the present invention are able to provide high performance notch filters that are improved over conventional transmissive thin film designs with respect to each of the previously mentioned performance characteristics (i) to (v). Notch filter apparatus formed using the approach of the present invention provide narrower band widths than are available using conventional thin film notch filters of the transmissive type, with high levels of blocking and without the tradeoff between band width and blocking that is characteristic of transmissive designs. Using spectral inversion allows broad passbands with high transmission and low levels of ripple. Thus, the thin film notch filters of the present invention are capable of higher performance than conventional transmissive thin film notch filters. Embodiments of the present invention also take advantage of improved edge characteristics and other design advantages of interference filters of band pass designs.

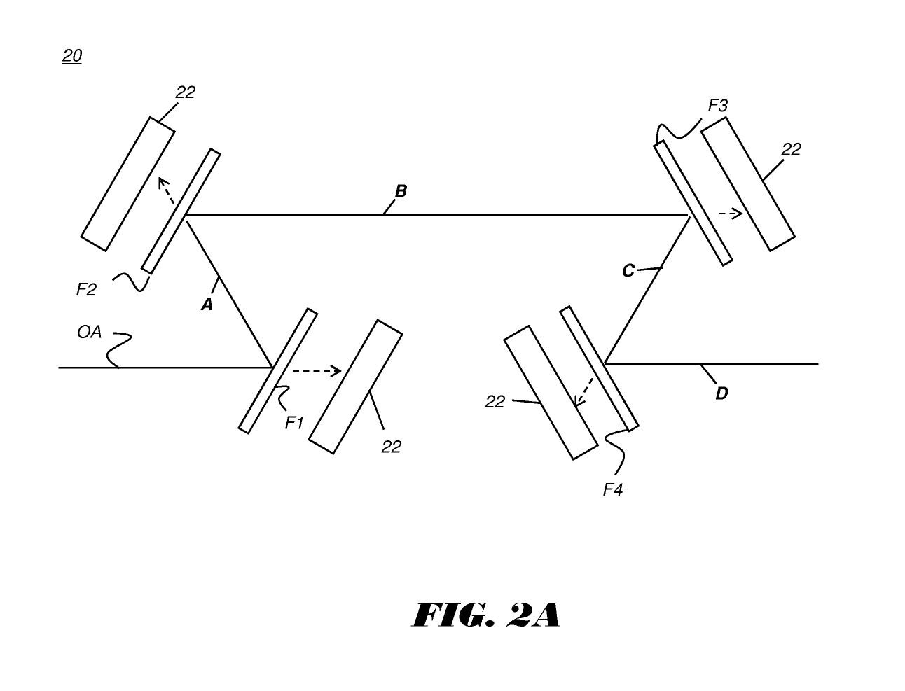

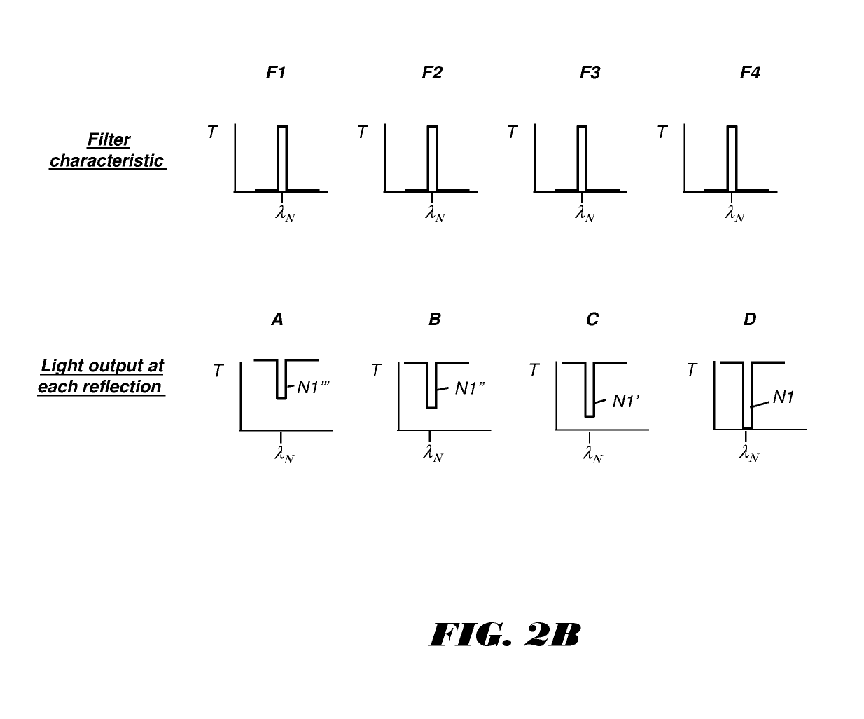

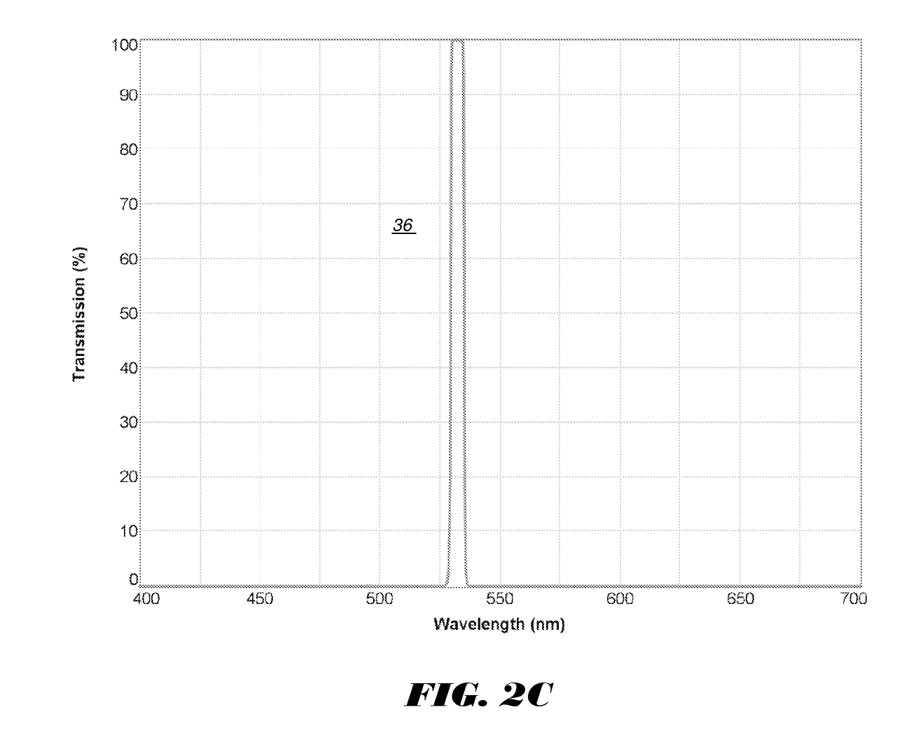

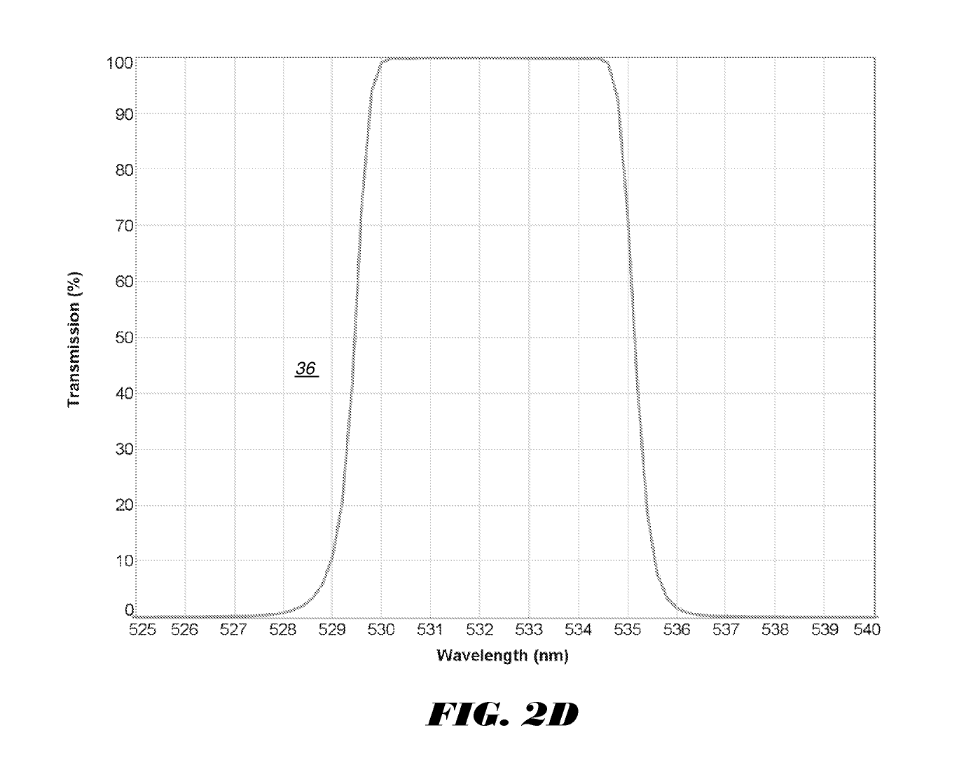

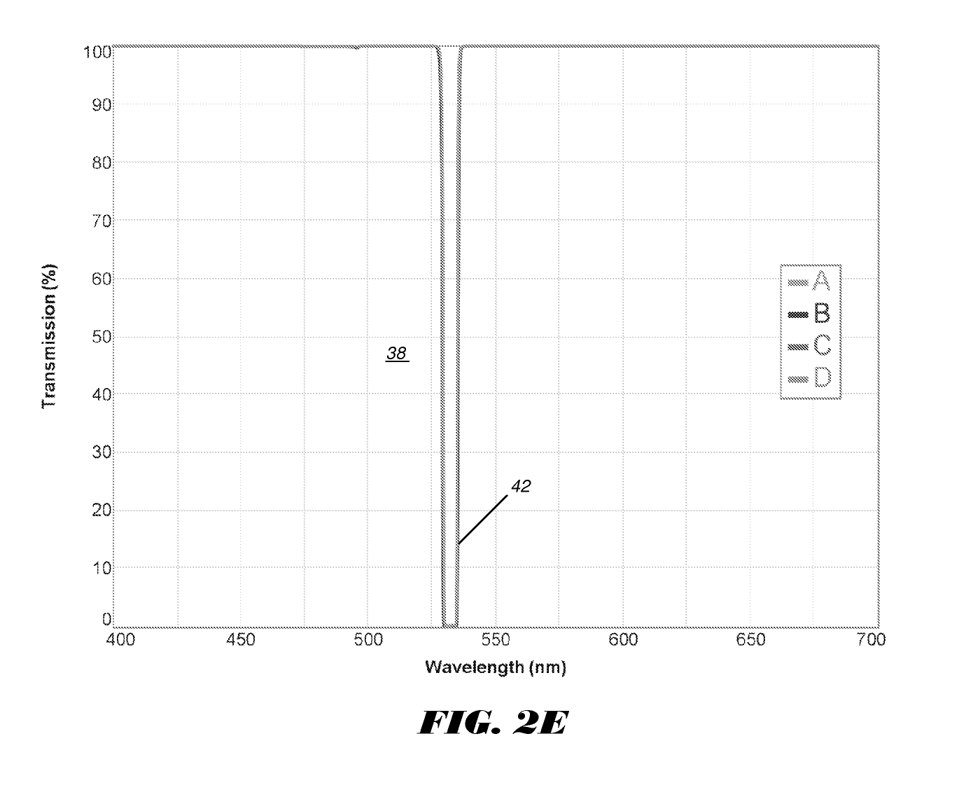

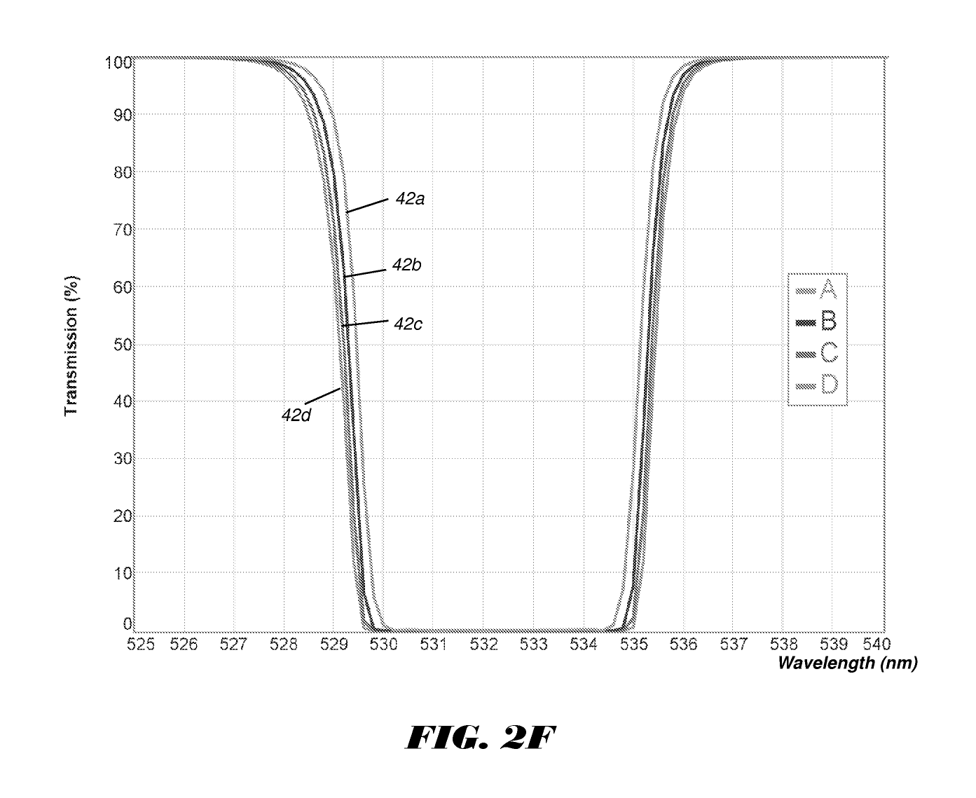

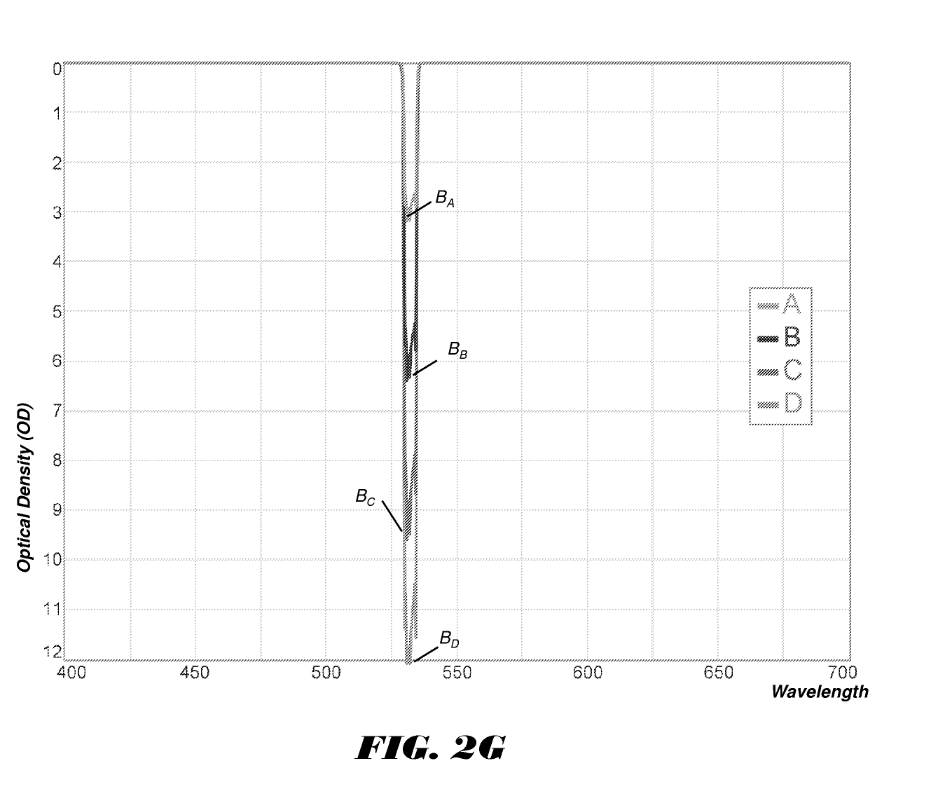

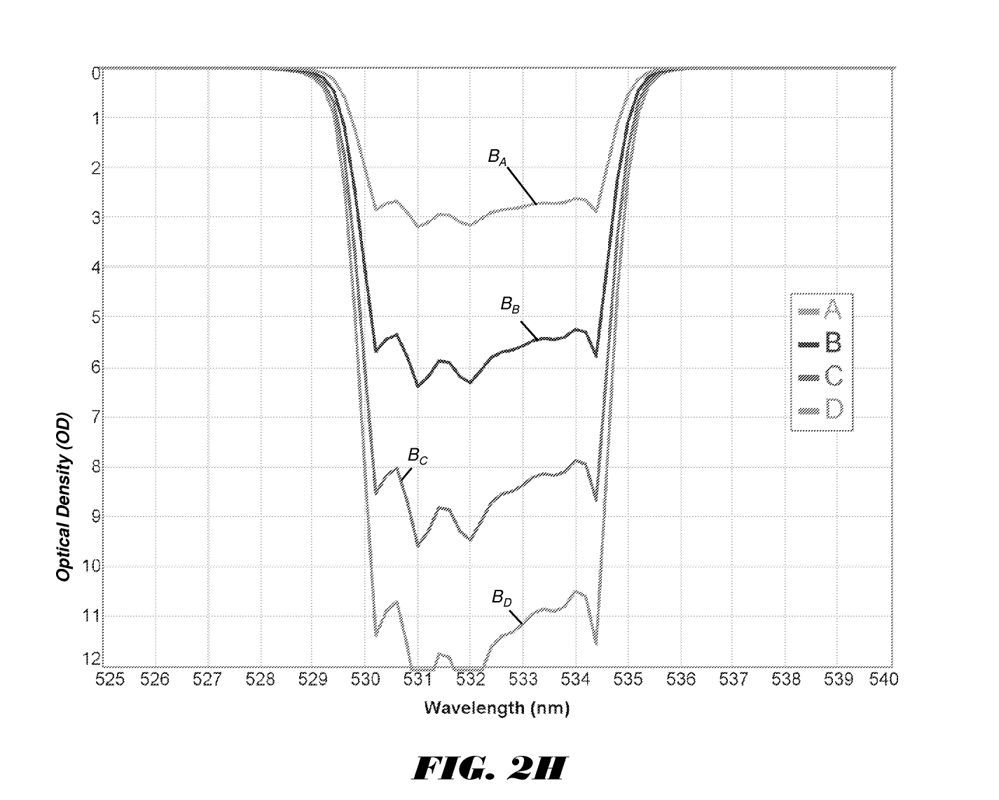

Referring to FIG. 2A, there is shown an optical notch filter apparatus 20 having a notch filter spectral characteristic that transmits less than 5% of incident light that lies within a notch spectral range having a central line wavelength λN and having a notch bandwidth NBW, and that transmits more than 90% of the light within a transmission spectral range TR that extends over an adjacent pass band of longer wavelengths than the notch spectral range (PB2 in FIG. 1A) and an adjacent pass band of shorter wavelengths (PB1 in FIG. 1A) than the notch spectral range and excludes the notch spectral range. The span or extent of the notch bandwidth NBW at full width half transmission is less than 5% of the central line wavelength λN. In embodiments of the present invention, notch bandwidth NBW at full width half transmission is less than 3% of the central line wavelength λN. Other embodiments of the present invention provide notch bandwidths NBW of less than 2% or of less than 1% of the central line wavelength λN.

FIG. 2A shows a first thin film interference filter F1 at an oblique angle to incident light. Interference filter F1 is a narrow pass band filter that reflects rejected light, that is, light outside the narrow pass band, toward a second thin film interference filter F2 that lies in the path of the incident light reflected from first thin film interference filter F1. Light that transmits through each successive filter may be blocked, such as by a blocker 22 that absorbs light, or may be otherwise directed away from the optical system. Additional thin film interference filters F3 and F4 are each similarly in the path of reflected light within optical filter apparatus 20 and are similarly constructed.

In the embodiment of FIG. 2A, both of the first and second thin film interference filters F1 and F2 are treated to transmit light of the notch spectral range and to reflect light of the transmission spectral range TR that lies outside the notch spectral range and extends over an adjacent pass band of longer wavelengths than the notch spectral range and an adjacent pass band of shorter wavelengths than the notch spectral range. The first and second thin film interference filters F1 and F2 each comprise a corresponding substrate with a plurality of layers formed on the substrate, the plurality of layers including at least a plurality of first layers having a first refractive index, n_{L} interleaved with a plurality of second layers having a second refractive index, n_{H}, greater than the first refractive index. One or more additional layers having refractive indices not equal to either n_{H} or n_{L} may also be provided in the stack. The reflected light from interference filter F2 is directed to interference filter F3. Similarly, reflected light from interference filter F3 is directed to interference filter F4. Interference filters F3 and F4 similarly each comprise a corresponding substrate with a plurality of layers formed on the substrate, the plurality of layers including at least a plurality of first layers having a first refractive index, n_{L} interleaved with a plurality of second layers having a second refractive index, n_{H}, greater than the first refractive index. One or more additional layers having refractive indices not equal to either n_{H} or n_{L} may also be in the F3 or F4 filter stack. One or more blockers 22 are provided to absorb transmitted light, so that it is removed from the optical path. Blocker 22 for filter F1 helps to prevent the unwanted transmitted light of notch band wavelengths from being inadvertently directed through filter F4; the other blockers 22 shown in FIG. 2A are of less value for this particular arrangement and, therefore, are optional. Blocker 22 can be any type of device or surface that absorbs or otherwise blocks incident light energy.

In the arrangement shown in FIG. 2A, each of filters F1, F2, F3, and F4 is configured as a narrow band pass filter. The top row of FIG. 2B shows the respective filter characteristics for each of these filters in idealized, schematic form. In the embodiment shown, each band pass filter F1-F4 has the same spectral characteristic, shown for transmission of a narrow band around the desired notch central line wavelength λ_{N}. The bottom row of FIG. 2B shows, as a progression, the resulting spectral characteristics of the light that is reflected from each of filters F1 through F4. These graphs show transmission, with notch N1 as it is formed by each reflection, in exaggerated form for clarity of description. At reference location A, reflected light from filter F1 generates a notch N1′″. At reference location B, reflected light from filter F2 generates a notch N1″ with deeper blocking than notch N1′″ but with negligible broadening of the notch bandwidth. Similarly, at reference location C, reflected light from filter F3 generates a notch N1′ with deeper blocking than notch N1″ and, again, with negligible broadening of the notch bandwidth. Finally, the output of optical filter apparatus 20 at reference location D shows reflected light from filter F4 that provides notch N1, with the desired blocking and, once again, showing negligible broadening of the notch bandwidth.

The graph of FIG. 2C shows a spectral characteristic 36 for each of filters F1 through F4 in the filter 2A embodiment. Spectral characteristic 36, given in terms of transmission %, is for a band pass filter and is shown, in this example, for an angle of incidence (AOI) of 45 degrees for light of average polarization. With the band pass filter, light of a specified spectral range transmits through the filter. FIG. 2C shows characteristics for a band pass filter that has been designed with negligible polarization splitting, using techniques described in commonly assigned U.S. patent applications Ser. No. 12/129,534 and Ser. No. 12/684,871, both incorporated herein by reference. Using the design techniques taught in these applications, the change in notch bandwidth for orthogonal s- and p-polarization states is not noticeable. The graph of FIG. 2D shows spectral characteristic 36 of FIG. 2C at an enlarged wavelength scale.

The graph of FIG. 2E shows a spectral characteristic 38 from reflection for each of filters F1 through F4 in the filter 2A embodiment. Spectral characteristic 38 is inverted from its corresponding transmissive spectral characteristic 36 in FIG. 2C, so that light of the specified spectral range is blocked by the filter over a notch 42. The spectral characteristics at each of reference locations A, B, C, and D are overlaid at the scale shown. The graph of FIG. 2F is over an enlarged wavelength scale, in transmission %, and shows how notch 42 is progressively formed, as was described previously with reference to FIG. 2B. A notch 42a shows the notch filter spectral characteristic following filter F1 in FIGS. 2A and 2B; a notch 42b shows the spectral characteristic following filter F2 in FIGS. 2A and 2B; a notch 42c shows the spectral characteristic following filter F3 in FIGS. 2A and 2B; and a notch 42d shows the spectral characteristic following filter F4 in FIGS. 2A and 2B. The corresponding graphs of FIGS. 2G and 2H show, in log-scale units of optical density (OD), the progressive sequence by which a notch filter can be formed using spectral inversion. Blocking B_{A} corresponds to the blocking provided at reference location A by filter F1 in FIG. 2A. Blocking B_{B} corresponds to the blocking provided by filter F2 at reference location B in FIG. 2A. Blocking B_{C} corresponds to the blocking provided by filter F3 at reference location C in FIG. 2A. Blocking B_{D} corresponds to the blocking provided by filter F4 at reference location D in FIG. 2A.

Relative to the spectral inversion embodiment shown in FIG. 2A and with characteristics shown in the graphs of FIGS. 2B-2H, a number of observations can be made, including the following:
(i) Narrow notch band width. The bandwidth is determined by characteristics of the bandpass filter at the angle of incidence, taking into account such characteristics as polarization splitting and edge steepness. Spectral inversion allows notch band widths much narrower than those available with conventional transmissive thin film notch filter configurations. Notch bandwidths NBW of less than 2% or even of less than 1% of the central line wavelength λN at FWHT are achievable with this approach. This performance characteristic is largely determined by the band pass filters used, rather than by number of reflections. Repeated reflection from each successive band pass filter F1, F2, F3, and F4 decreases, that is, improves, the edge steepness.
(ii) Improved blocking. Repeated reflection from each successive band pass filter F1, F2, F3, F4 improves the blocking level, allowing optical filter apparatus 20 to provide a notch filter having high attenuation of the notch wavelength with four reflections. 6 OD or better performance is generally preferred, although lower performance may be suitable for some applications. Relaxing this requirement can reduce some constraints on filter dimensions and on the number of filters and reflections needed.
(iii) Broad pass bands. Pass band transmission is not highly dependent on the number of reflections. Spectral inversion takes advantage of the high levels of reflectivity that can be achieved using thin film designs. The TR range that surrounds the notch can span a combined range of 800 nm or more and can include wavelengths in both the ultraviolet (below about 400 nm) and infrared regions (above about 750 nm).
(iv) High transmission over the transmission spectral range TR outside of the notch region. Related to the extent of TR in (iii) above, uniformly high transmission over pass bands PB1 and PB2 is achieved using spectral inversion. Transmission levels are higher than those conventionally achieved with transmissive thin film designs. Transmission levels in excess of 95% can be readily achieved with spectral inversion.
(v) Low ripple. Spectral inversion using the embodiment of FIG. 2A provides low ripple, greatly reduced over ripple levels encountered in conventional transmissive thin film notch filter designs. Ripple is low because the light transmitted by the overall arrangement results from reflection from each thin film filter, and this reflection is very constant on a linear scale.

In an alternate embodiment using the basic arrangement shown in FIG. 2A, one or more of filters F1, F2, F3, and F4 differ from each other, such as by having different filter characteristics. One or more of these filters can be a mirrored surface, or may provide some other filtering useful for conditioning filter behavior.

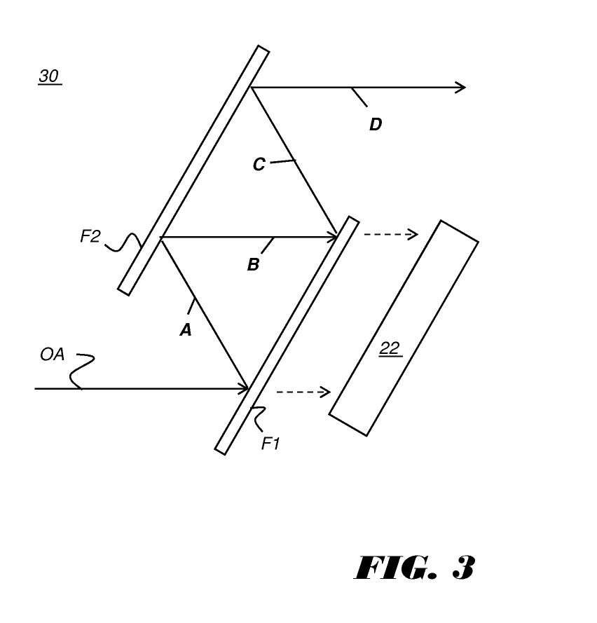

The schematic block diagram of FIG. 3 shows an alternate embodiment of the present invention with an optical notch filter apparatus 30 using two filters F1 and F2. Here, the optical path provides a cascading filter arrangement that allows light to be reflected from each filter multiple times. The filters used have similar characteristics and behavior to that described previously with reference to FIGS. 2B through 2H. Using the FIG. 3 configuration, the output optical axis is displaced from the input optical axis, but is substantially in parallel (that is, to within +/−5 degrees) with the input axis.

In an alternate embodiment, filters F1 and F2 have different characteristics. Filter F1 is a minor, according to an embodiment of the present invention; alternately, filter F2 can be a mirror. Additional reflections from the filter surface would be used to achieve the needed blocking.

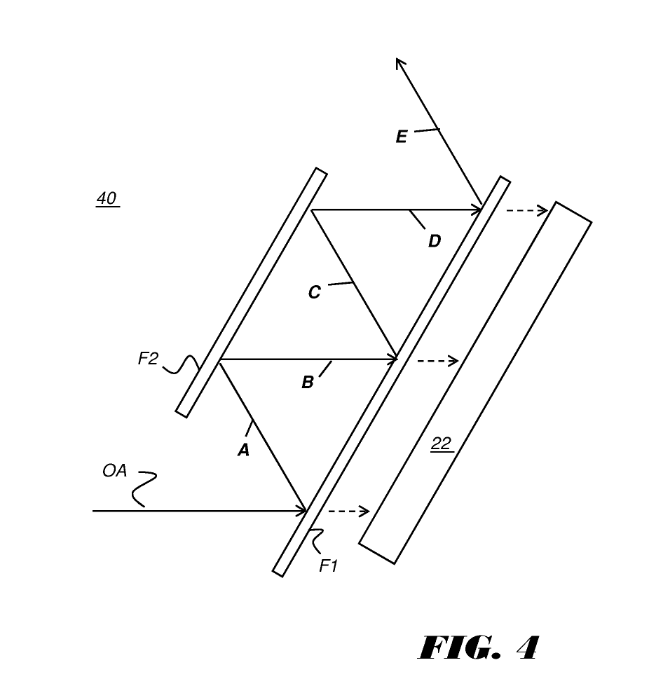

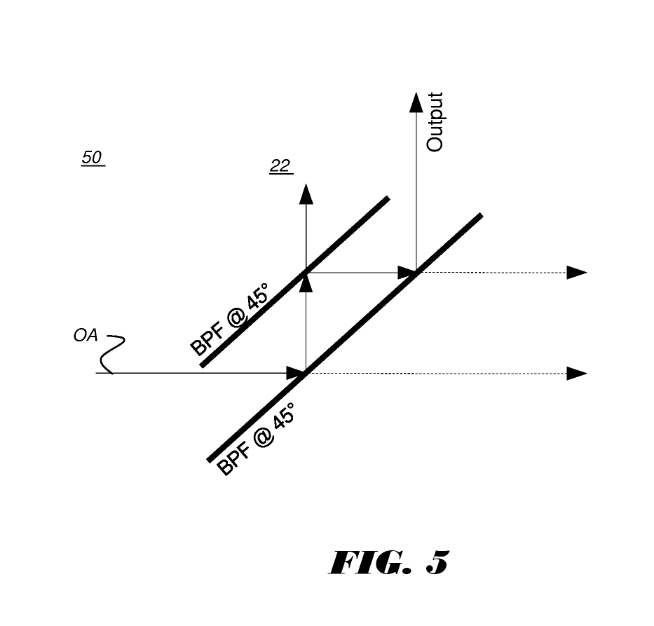

The schematic block diagram of FIG. 4 shows an alternate embodiment of an optical notch filter apparatus 40 of the present invention using two filters F1 and F2. In the embodiment shown, output light at reference position E is not parallel to the input axis, but is directed along a vector that points away from the input axis. Similar analysis to that provided for the FIG. 2A and 3 embodiments also applies for FIG. 4. According to an embodiment of the present invention that follows the basic pattern of FIG. 4 and is shown in an optical notch filter apparatus 50 in FIG. 5, filters F1 and F2 are disposed at angles relative to the input axis so that the output light is substantially orthogonal (to within +/−5 degrees) to the input axis.

Polarization splitting can be a function of angle of incidence (AOI). In general, increased AOI leads to increased polarization splitting, so that s- and p-polarization characteristics vary at edge transitions. For conventional thin film designs, polarization splitting can be acceptable for AOI within a limited range of values, such as only as large as 5 to 10 degrees or less for some designs, or up to 30 degrees or less for other designs. However, commonly assigned copending U.S. patent application Ser. No. 12/129,534, incorporated herein by reference, describes a filter designed for high angles of incidence with very steep edges and low polarization splitting, and U.S. Patent Application Publication No. 2011/0170164 entitled “TUNABLE THIN-FILM FILTER” by Ligang Wang, incorporated herein by reference, describes tunable band pass filters, also operating a high angles of incidence with very steep edges and low polarization splitting. Both applications describe approaches for filter design that reduce polarization splitting using so-called “pass band defects,” deliberately induced localized conditions in the pass band above or below an edge transition that help to more closely align s- and p-polarization characteristics at the transition associated with the defect. Other approaches for reducing polarization splitting include selecting thin film materials that have less contrasting indices of refraction. Embodiments of the present invention are capable of achieving very low levels of polarization splitting, to less than 0.5% of the central notch wavelength or central line wavelength λN for each orthogonal polarization. This means that for each edge of the notch region that is formed, the edge wavelength for p-polarization is within 0.5% of the edge wavelength for s-polarization. Thus, the notch bandwidth NBW for light having one polarization state can be as much as 1% wider than the notch bandwidth NBW for the orthogonal polarization state.

FIGS. 3, 4, and 5 show embodiments that take advantage of multiple reflections from the same filter surface or surfaces. This type of embodiment offers simplified alignment, single-piece construction, and other benefits for cascaded filter design using spectral inversion. A number of alternative approaches for filter alignment are also available, including embodiments that provide advantages such as multiple reflections or multiple passes through transmissive filters, built-in alignment, and beam redirection.

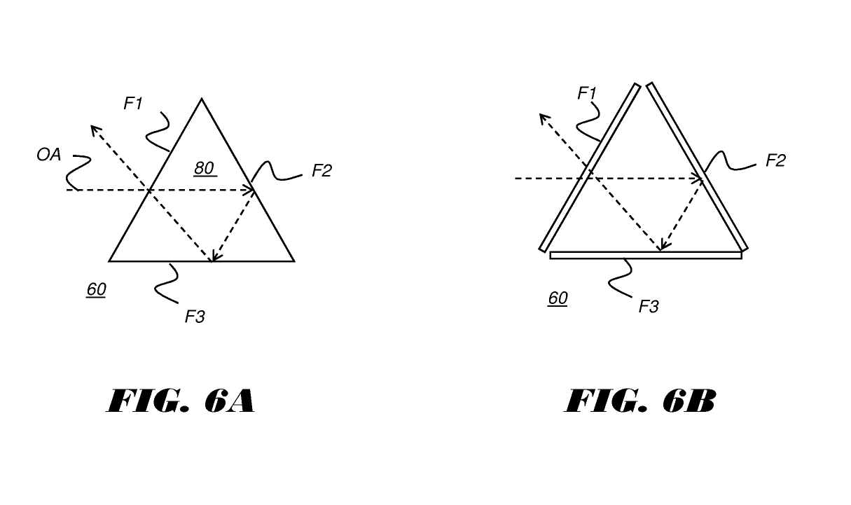

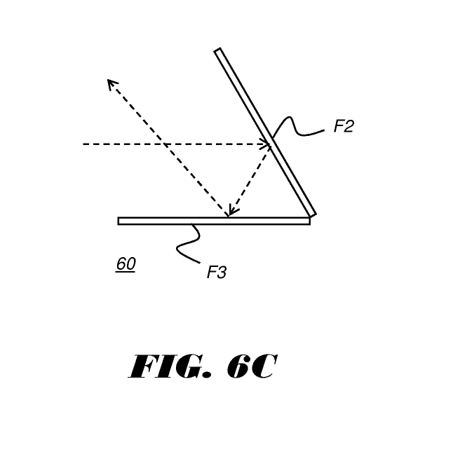

In addition to reflection, some amount of transmissive filtering may also be useful in the notch filter arrangement. The schematic diagrams of FIGS. 6A and 6B show alternate arrangements of an optical notch filter apparatus 60 using three filters: a filter F1 used in transmission and two filters F2 and F3 used in reflection. This configuration provides two transmissions through filter F1. In FIG. 6A, optical filter apparatus 60 is formed on a solid transparent body of a prism 80, with filters formed on optical prism surfaces, for example. In FIG. 6B, optical filter apparatus 60 is formed as an arrangement of filters and provides similar treatment of the light, with two transmissions (F1) and two reflections (F2 and F3). FIG. 6C shows optical filter apparatus 60 without filter F1.

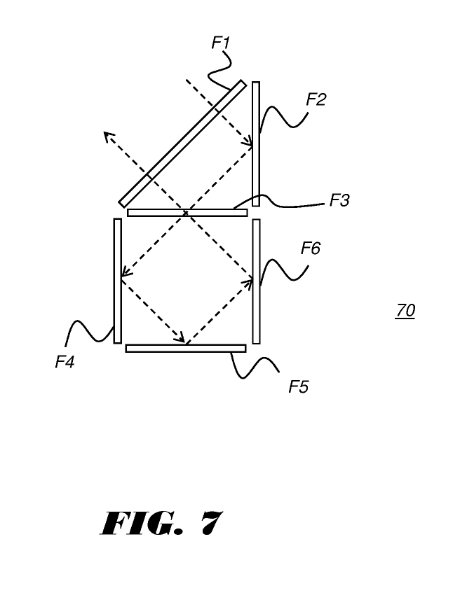

The schematic block diagram of FIG. 7 shows an arrangement of an optical notch filter apparatus 70 having two filters F1 and F3 used in transmission and four filters F2, F4, F5, and F6 used in reflection. Transmission through each of filters F1 and F3 occurs twice with the arrangement shown. The output light path is parallel to the incident light path and in the opposite direction with this arrangement. Filter F1 is optional, as is filter F3.

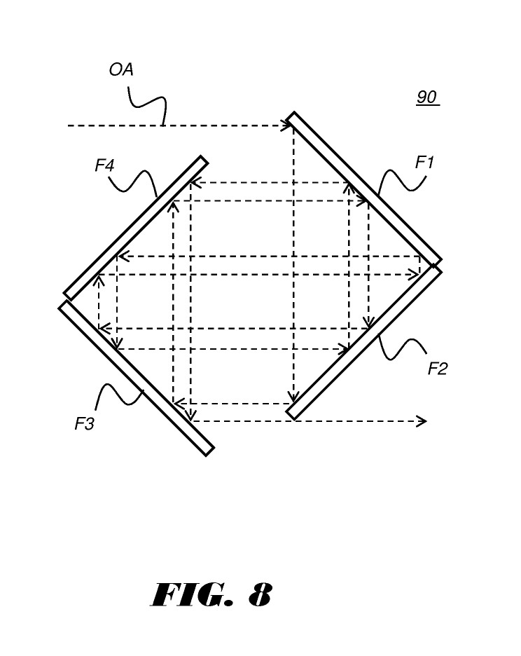

The schematic block diagram of FIG. 8 shows an alternate embodiment of the present invention with an optical notch filter apparatus 90 having four filters F1, F2, F3, and F4, each used in reflection. There are four reflections from each filter in this embodiment. The output light path is parallel to the incident light along axis OA in this arrangement.

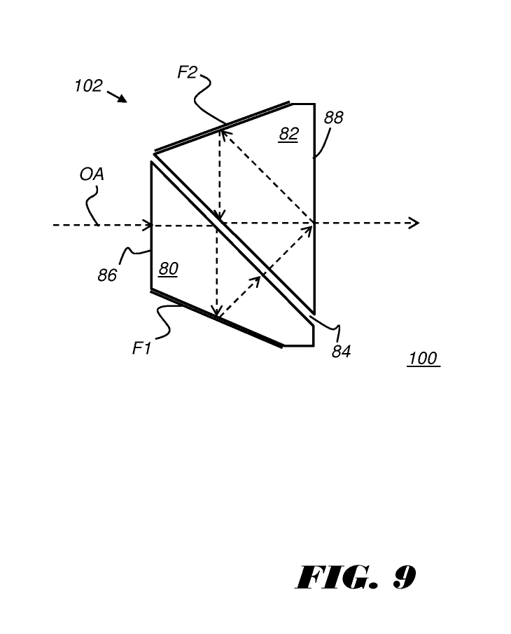

Composite filter apparatus, formed by combinations of two or more prism elements, with or without an air gap between prism elements, can be advantageously adapted as embodiments of a notch filter apparatus using spectral inversion. As one example, FIG. 9 shows an optical notch filter apparatus 100 that is formed on a composite prism 102, shown as a Pechan prism. The Pechan prism is a well-known composite prism type, used conventionally as an image rotator for light incident on its input face 86 and exiting an output face 88. The Pechan prism is conventionally formed from two prisms 80 and 82 that are separated from each other by an air gap 84. Filters F1 and F2 are formed on surfaces of the Pechan prism where light is not directed at a normal and does not undergo total internal reflection (TIR). Other composite prism embodiments that provide multiple filter surfaces, use TIR, and that offer an extended optical path length can be realized.

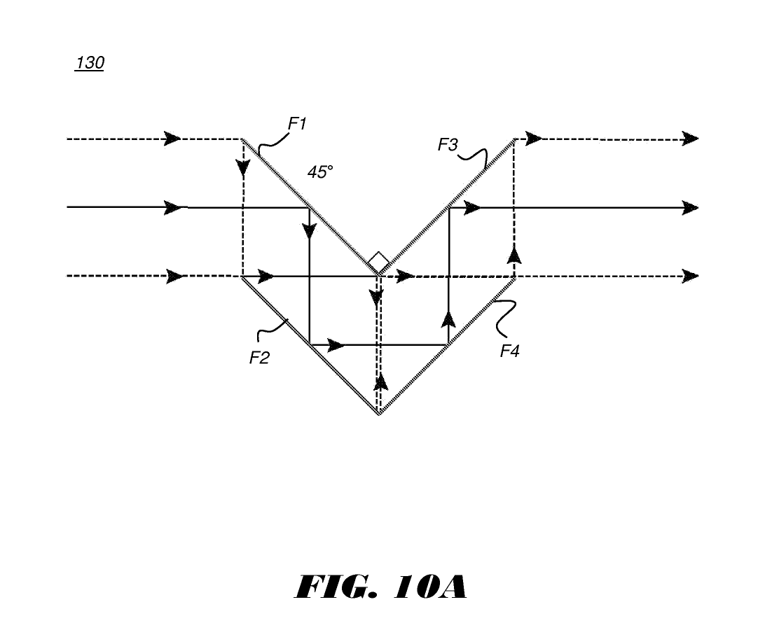

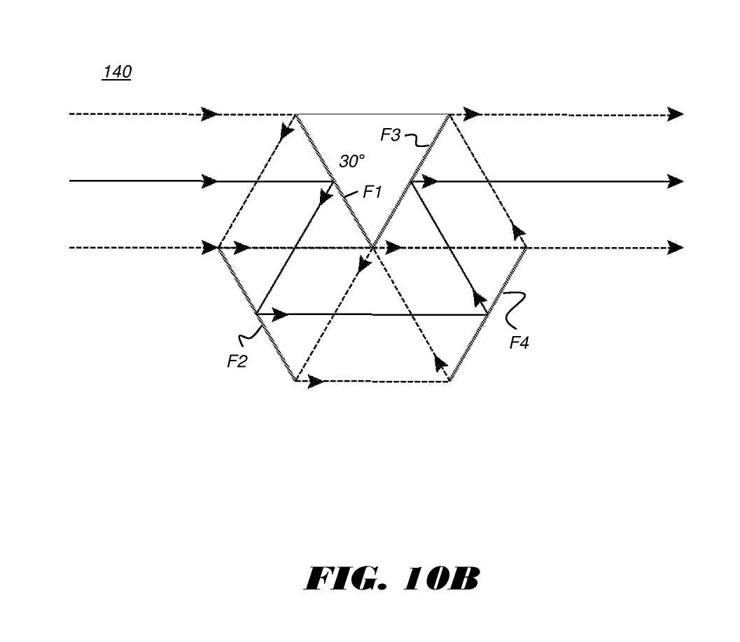

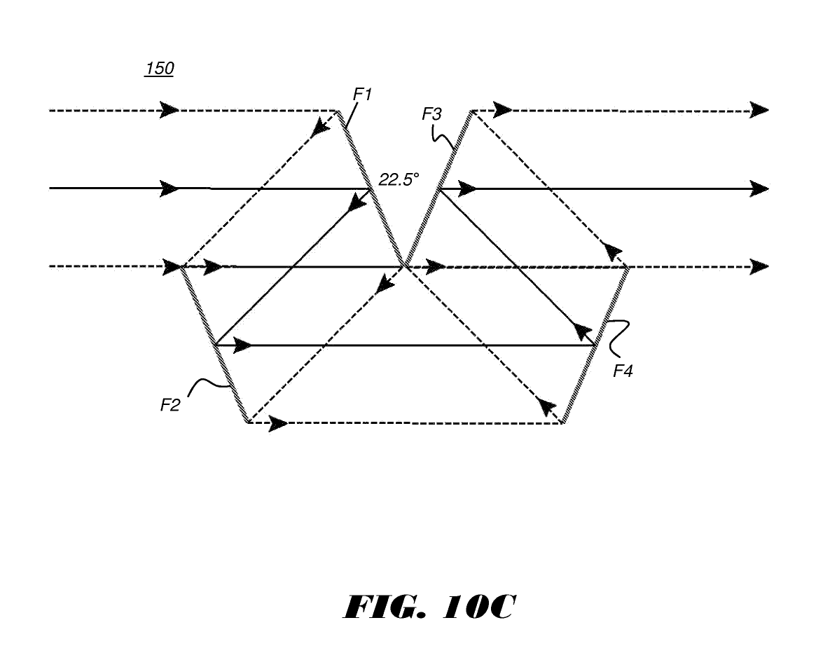

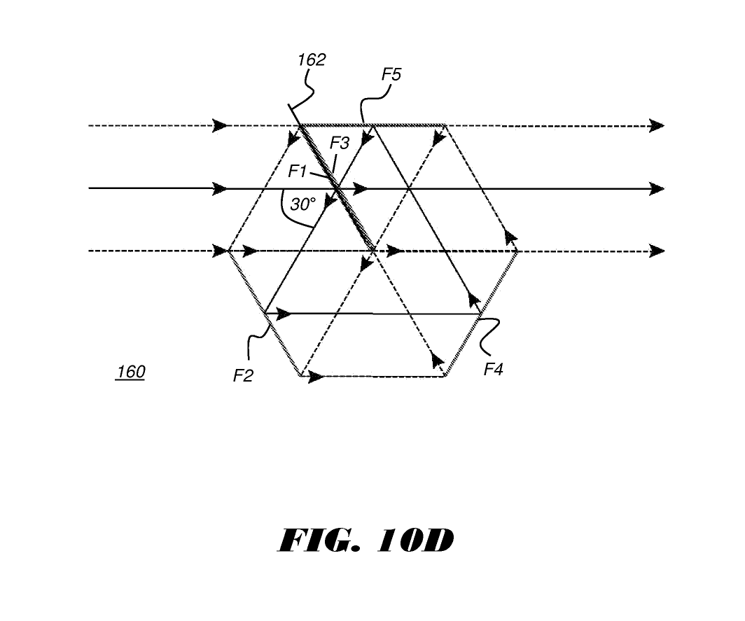

In order to replace existing notch filters of transmissive design with notch filters formed using spectral inversion according to embodiments of the present invention, it is often preferable to provide the output light along the same axis as the input light. Embodiments shown in FIGS. 10A-10D show various configurations using two or more thin film interference filters in embodiments with the filters formed onto prism surfaces or formed separately.

The schematic block diagram of FIG. 10A shows a notch filter apparatus 130 formed using filters F1-F4 that are either formed on separate substrates (as shown) or, alternately, formed onto a transparent prism that is formed of a material having a suitable index of refraction. Light is incident to filter F1 at 45 degrees. With this arrangement, four reflections from filter surfaces are provided for each portion of the incident light.

The schematic block diagram of FIG. 10B shows a notch filter apparatus 140 formed using filters F1-F4, with light incident at about 30 degrees. Notch filter apparatus 140 may use filters that are formed onto individual substrates or may be formed onto a transparent prism, as described previously.

FIG. 10C shows rearrangement of filters F1-F4 for incident light of 22.5 degrees in an alternate embodiment of an optical notch filter apparatus 150. FIGS. 10A through 10C demonstrate the trade-off between achieving a more compact overall apparatus and reducing the angle of incidence to mitigate polarization splitting effects. Both are desirable, but the more compact the apparatus, the larger the angle of incidence, and the smaller the angle of incidence, the larger the apparatus.

The schematic block diagram of FIG. 10D shows how additional filters can be used in an optical notch filter apparatus 160. In the FIG. 10D embodiment, the input beam is inverted. Filters F1 and F3 are arranged back to back, with a blocker 162 between them to eliminate leakage of unwanted light. Filter F5 is optional and could be a minor surface; where this surface is a filter, five reflections from filters are provided for the incident light. Incident light to filter F1 is at 30 degrees in the embodiment shown in FIG. 10D.

Using spectral inversion, embodiments of the present invention take advantage of favorable aspects of thin film interference filters in reflection and utilize these advantages to provide notch filters that can exceed the performance of conventional transmissive notch filters in a number of ways. It can be appreciated that the embodiments shown are by way of example and are not intended to be limiting. A number of alternative prism embodiments can be envisioned, for example, taking advantage of opportunities for multiple reflections from coated surfaces and total internal reflection from non-coated surfaces for various types of single-body and composite prisms. Various aspects of prism behavior, such as image rotation, may also be beneficial in embodiments of the present invention. The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention.

1. An optical filter apparatus that transmits less than 5% of incident light that lies within a notch spectral range about a central line wavelength λN and having a notch bandwidth NBW, and that transmits more than 90% of the light within a transmission spectral range TR that extends over an adjacent pass band of longer wavelengths than the notch spectral range and over an adjacent pass band of shorter wavelengths than the notch spectral range and excludes the notch spectral range, the optical filter apparatus comprising:
a first thin film interference filter; and
at least a second thin film interference filter in the path of the incident light reflected from the first thin film interference filter;
wherein the first and the at least the second thin film interference filters are each formed to transmit light of the notch spectral range and to reflect light of the transmission spectral range TR,
wherein the first and second thin film interference filters each comprise a corresponding substrate with a plurality of thin film layers formed on the substrate, the plurality of layers including at least a plurality of first layers having a first refractive index, n_{L} and a plurality of second layers having a second refractive index, n_{H}, greater than the first refractive index;
wherein the notch bandwidth NBW at full width half transmission is less than 5% of the central line wavelength λN.

2. The apparatus of claim 1 wherein at least the first thin film interference filter is formed on a surface of a prism.

3. The apparatus of claim 1 wherein the apparatus transmits less than 1% of incident light within the notch spectral range.

4. The apparatus of claim 1 wherein the notch bandwidth NBW at full width half transmission is less than 3% of the central line wavelength λN.

5. The apparatus of claim 1 wherein the notch bandwidth NBW at full width half transmission is less than 2% of the central line wavelength λN.

6. The apparatus of claim 1 wherein the incident light is directed along an optical axis and wherein the first thin film interference filter is oblique to the optical axis.

7. The apparatus of claim 1 wherein the notch bandwidth NBW does not vary by more than 1% of the central line wavelength λN for incident light of orthogonal polarization states.

8. The apparatus of claim 1 further comprising a third thin film interference filter in the path of the incident light reflected from the second thin film interference filter.

9. The apparatus of claim 1 wherein the first and second thin film interference filters are in parallel planes.

10. The apparatus of claim 1 wherein the incident light is reflected from each of the first and second thin film interference filters at least twice.

11. The apparatus of claim 1 wherein filtered light output from the filter apparatus is substantially parallel to the incident light.

12. The apparatus of claim 1 wherein filtered light output from the filter apparatus is substantially orthogonal to the incident light.

13. The apparatus of claim 1 wherein the plurality of layers on the first and second thin film interference filters further comprise one or more third layers having a third refractive index n₃ that is not equal to indices n_{L} and n_{H}.

14. The apparatus of claim 1 wherein the first and at least second thin film interference filters are formed on different surfaces of an optical prism element.

15. The apparatus of claim 1 wherein the first thin film interference filter is formed on a first prism element and the at least second thin film interference filter is formed on a second prism element and wherein there is an air gap between the first and second prism elements.

16. An optical filter apparatus that transmits less than 5% of incident light that lies within a notch spectral range having a central line wavelength λN and having a notch bandwidth NBW, and that transmits more than 90% of the light within a transmission spectral range TR that extends over an adjacent pass band of longer wavelengths than the notch spectral range and over an adjacent pass band of shorter wavelengths than the notch spectral range and excludes the notch spectral range, the optical filter apparatus comprising:
a first thin film bandpass filter that is disposed at an oblique angle of at least 5 degrees with respect to an optical axis of the incident light;
a second thin film bandpass filter in the path of the light reflected from the first thin film bandpass filter;
a third thin film bandpass filter in the path of the light reflected from the second thin film bandpass filter; and
a fourth thin film bandpass filter in the path of the light reflected from the third thin film bandpass filter,
wherein the first, second, third, and fourth thin film bandpass filters each comprise a corresponding substrate with a plurality of layers formed on the substrate, the plurality of layers including at least a plurality of first layers and a plurality of second layers, the first layers having a first refractive index, n_{L} and the second layers having a second refractive index, n_{H}, greater than the first refractive index;
wherein the first, second, third, and fourth thin film bandpass filters are each formed to reflect light outside the notch spectral range and to transmit light of the notch spectral range,
and wherein notch bandwidth NBW at full width half maximum is less than 3% of the central line wavelength λN.

17. The apparatus of claim 16 wherein the transmission spectral range TR spans a combined range of at least 800 nm.

18. The apparatus of claim 16 wherein the transmission spectral range TR comprises wavelengths in both the ultraviolet region and the infrared region.

19. The apparatus of claim 16 wherein total internal reflection is used to fold the light path between the first and the second thin film filter.

20. An optical filter apparatus that blocks, with an optical density of at least 4, incident light that lies within a notch spectral range about a central line wavelength λN and having a notch bandwidth NBW, and that transmits more than 90% of the light within a transmission spectral range TR that extends over an adjacent pass band of longer wavelengths than the notch spectral range and over an adjacent pass band of shorter wavelengths than the notch spectral range and that excludes the notch spectral range, the optical filter apparatus comprising at least a plurality of thin film layers formed on a substrate, the plurality of layers including at least one or more first layers having a first refractive index, n_{L} and one or more second layers having a second refractive index, n_{H}, greater than the first refractive index, wherein the notch bandwidth NBW at full width half transmission is less than 2% of the central line wavelength λN.
